(19) United States
(12) Patent Application Publication
(10) Pub. No.: US 2008/0041796 A1
(43) Pub. Date: Feb. 21, 2008

(54) High back pressure filter for removing non-water component(s) from water

(76) Inventor: John C. Ruprecht, North Oaks, MN (US)

Correspondence Address: JAMES D. WELCH, 10328 PINEHURST AVE., OMAHA, NE, 68124, US

(21) Appl. No.: 11/973,617

(22) Filed: Oct. 10, 2007

Related U.S. Application Data
(63) Continuation-in-part of application No. 11/452,012, filed on Jun. 14, 2006.
(60) Provisional application No. 60/694,093, filed on Jun. 27, 2005.

(51) Int. Cl. B01D 17/02

(52) U.S. Cl. 210/799; 210/464; 210/474

(57) ABSTRACT

A system, and method of use, for entering a mixture of a non-water component and water thereinto, which develops a high back pressure, and via causing said mixture to pass through a mixture of polypropylene and beads in an upper approximately ⅔ thereof, and polypropylene in the lower approximately ⅓ thereof, providing water at an outlet from which the non-water component has been removed.

This Application is a CIP of Pending application Ser. No. 11/452,012 Filed Jun. 14, 2006 and therevia Claims benefit Provisional Application Ser. No. 60/694,093 Filed Jun. 27, 2005.

### TECHNICAL FIELD

The presently disclosed invention relates to systems for removing non-water component(s) from liquids, and more particularly to a system for entering a mixture of non-water (e.g. oil) and water thereinto which develops a high back pressure, and via causing said mixture to pass through a mixture of polypropylene and beads in an upper majority thereof, and polypropylene in the lower minority thereof, providing water at an outlet from which the non-water component has been removed.

### BACKGROUND

It is known to remove non-water (e.g. oil) component(s) from liquids such as water using filtering means.

With the present invention in mind, a Search of Patents was conducted and identified:
U.S. Pat. No. 6,015,494 to Siverling et al. describes a oil/water separator using a polyolefin sheets;
U.S. Pat. No. 4,913,815 to Shulda describes a concentric dual bag filer having an inlet and outlet, and polypropylene filter means in a dual bag;
U.S. Pat. No. 4,839,040 to Alm describes a filter apparatus for purifying oil contaminated water that has cylindrical outer and inner shells;
U.S. Pat. No. 4,282,097 to Kuepper et al., describes a method of separating oil and water through coalescer tubes made from water permeable fibers. Use of polypropylene is mentioned;
U.S. Pat. No. 3,830,371 to Garcia describes using polypropylene in an apparatus for separating oil and water by passage through a cylindrical shaped space;
U.S. Pat. No. 3,617,548 to Willihnganz describes a method for separating oil and water by passage through a polypropylene mesh. The discussion regarding the 371 Patent is generally applicable;
Patent RE 31,047 to Ross describes a method for separating oil from water by passage through a fiber web involving use of polypropylene.
U.S. Pat. No. 5,948,253 to Hearn is also disclosed as relevant.

Additionally, Prior Patents identified by the Examiner in the examination process of the parent application, Ser. No. 11/452,012 from which this application continues are Nos.:
U.S. Pat. No. 1,756,862 to Hastings;
U.S. Pat. No. 3,583,904 to Winston;
U.S. Pat. No. 4,122,011 to Strigle;
U.S. Pat. No. 4,948,402 to Forbes;
U.S. Pat. No. 5,204,027 to Armstrong et al.;
U.S. Pat. No. 5,217,616 to Sanyal et al.;
U.S. Pat. No. 5,227,055 to Timmons;
RE 35,234 to Forbes;
U.S. Pat. No. 5,558,763 to Funakoshi et al.;
U.S. Pat. No. 5,573,663 to Junius et al.;
U.S. Pat. No. 5,945,005 to Junius et al.;
U.S. Pat. No. 6,315,896 to Johnson;
U.S. Pat. No. 4,115,266 to Oshima;
U.S. Pat. No. 4,213,863 to Anderson;
U.S. Pat. No. 4,624,765 to Cerkanowics et al.;
U.S. Pat. No. 4,744,889 to Kruyer;
U.S. Pat. No. 5,229,015 to Keep et al.;
U.S. Pat. No. 7,021,471 to Abrams.

Published Application US 2004/0112823 by Benachenou et al. is disclosed as it was identified by the Examiner during examination of the parent application Ser. No. 11/452,012 as being particularly relevant. Applicant notes that the '823 Application states in Para. 0038 that “The polymeric material in the first compartment may also need to be inspected periodically, and replaced if it becomes clogged . . . ”. The tendency to become clogged is a fundamental problem with the invention disclosed in the '823 Application, a problem that is solved by present invention. As will be appreciated by a reading of the Disclosure of the Invention Section of this Specification, the purpose of the beads in the present invention is to prevent clogging. Such use of the beads is novel. There is nothing in the '823 Application that corresponds to the beads of the present invention. Further, as shown by Para. 0036 the '823 Application invention is designed to continuously remove non-aqueous components by centrifugation. That is, the '823 Application acknowledges the central deficiency of the invention disclosed therein—the unavoidable creation of clogs—and provides a specific mechanism for the removal of such clogs. A novelty of the present invention is that it prevents such clogs from developing. Nothing in the '823 Application suggests the deletion of such capacity to centrifugally remove such clogs. It is, in fact a critical aspect of the '823 Application invention. The point is that nothing in '823 Application would lead one skilled in the art to eliminate the system associated therewith that performs the non-aqueous components removal to eliminate clogs, and thus, arrive at a system like that of the present invention, which prevents clogs from forming. For insight, the present invention provides beads in an upper aspect thereof to prevent clogging by non-aqueous components entered thereinto, and there is nothing in the '823 Application system which is similar thereto, and neither does the '823 Application suggest adding anything like the beads. Further, the '823 Application system comprises “Catchment Boxes” (50, 51, 52, 53) and oil drains (60, 61, 62, 63), and nothing in the '823 Application suggests their removal. Note that there is nothing in the present invention corresponding thereto. Also, while the present invention provides beads mixed with polypropylene and polypropylene with no physical barrier therebetween, both are present in one compartment. The system in the '823 Application provides separate compartments that have a physical barrier therebetween. Nothing in the '823 Application suggests removal of the physical barrier.

Need remains for a system for entering a mixture of, for instance, oil and water thereinto which develops a high back pressure, and which releases water which is separated from the oil. Preferably the system should not require use of polyolefin sheets or bags or fiber webbing, should provide a large mass of oil removing material rather than use limited inner and/or an outer shell(s) of a filter to do so, and should not separate oil and water through clogging prone coalescer tubes made from water permeable fibers using polypropylene. In addition, it should provide two different filtering material layers to remove the oil from the water to minimize clogging via the formation of a “hockey puck” of sorts in the oil removing material(s).

### DISCLOSURE OF THE INVENTION

The present invention system can be described as a filter for separating at least one additional component (e.g. oil) from water, comprising:
an outer enclosure having input and output means present thereon for entering a mixture of water and at least one additional component and exiting water, respectively, said outer enclosure being substantially closed on the sides and on the lower extent thereof, said outer enclosure having means for securing a top thereto;
a top;
an inner colander which is filled with a sequence of a mixture of polypropylene and beads in an upper majority thereof, and polypropylene in a lower minority thereof, and permeable means at the bottom thereof, said beads comprising means for ensuring that flow through said mixture of polypropylene and beads continues during use by preventing the additional component which is separated from water thereby, from forming a blockage to said flow.

The present invention provides that an upper majority, (e.g. ⅔), thereof have a media comprised of a combined mixture of beads packed to a functional compaction level in an enclosure, (e.g. as a non-limiting example an 8×36 inch cylinder). At the bottom of said enclosure there is an “end bell”, exemplified as comprising a 4 inch band of holes, optionally in a specific pattern and of a functional size. The top of the present invention is sealed with a top cap which has an exemplary, non-limiting, one (1) inch diameter hole in the center thereof through which, in use, oily water is pumped thereinto under pressure and, preferably at a functional pressure pulse rate. The result is that the present invention media adsorbs the oil from the water. It is noted that pulse action has been found to allow the present invention media to expand and have required contact time with the oily water to remove substantially all oil present. The pump increases the discharge pressure, which is the inlet pressure less a drop resulting across oil absorbed in present invention polypropylene media. The beads mixed with the polypropylene ensure that oily water will continue to flow through the present invention. If bead particulates are not present it has been found that the separated oil will collect in the polypropylene and create a blockage which prevents further flow of oily water therethrough. The lower minority, (e.g. ⅓), of the present invention is effectively 100% polypropylene packet to a functional density to effectively remove any trace oil from the oily water that was not captured in the top of the present invention. Clean water then discharges in a radial flow via the band of perforation (holes) located near the bottom end bell of the present invention housing.

The present invention system can be described as a filter for separating oil from water comprising:
an outer enclosure having input an output means present thereon for entering a mixture of water and oil and exiting water, respectively, said outer enclosure being substantially closed on the sides and on the lower extent thereof, said outer enclosure having means for securing a top thereto;
a top;
an inner colander which is filled with a sequence of a mixture of polypropylene and beads in an upper majority thereof, and polypropylene in a lower minority thereof, and permeable means at the bottom thereof, said beads comprising means for ensuring that oily water continues to flow through said mixture of polypropylene and beads, by preventing oil which is separated from water thereby, from forming a blockage thereto;
   such that in use a said top is secured to said outer enclosure and a mixture of oil and water is entered to the input means, flows through said mixture of polypropylene and beads, then through said polypropylene, and then through said permeable means at the bottom of the inner colander before water exits through said output means of the outer enclosure.

The terminology “upper majority” of the inner colander can represent approximately ⅔ of the total volume thereof, and the terminology “lower minority” of the inner colander represents approximately ⅓ of the total volume thereof.

A present invention method of separating oil from water comprises:
a) providing a filter as described just above; and
b) entering a mixture of oil and water to the input means and collecting water from the output means.

The mixture of oil and water can be entered in a pulsed manner.

Another present invention systems can be described as a filter for separating at least one additional component from water comprising:
an outer enclosure having input and output means present thereon for entering a mixture of water and at least one additional component and exiting water, respectively, said outer enclosure being substantially closed on the sides and on the lower extent thereof, said outer enclosure having means for securing a top thereto;
a top;
an inner colander which is filled with a sequence of a mixture of polypropylene and beads in an upper majority thereof, and polypropylene in a lower minority thereof, and permeable means at the bottom thereof, said beads comprising means for ensuring that oily water continues to flow through said mixture of polypropylene and beads, by preventing oil which is separated from water thereby, from forming a blockage thereto;
   such that in use a said top is secured to said outer enclosure and a mixture of said at least one additional component and water is entered to the input means, flows through said mixture of polypropylene and beads, then through said polypropylene, and then through said permeable means at the bottom of the inner colander before water exits through said output means of the outer enclosure.

Again, the terminology “upper majority” of the inner colander represents approximately ⅔ of the total volume thereof, and the terminology “lower minority” of the inner colander represents approximately ⅓ of the total volume thereof.

A present invention method of separating at least one additional component from water then comprises:
a) providing a filter as described just above; and
b) entering a mixture of said at least one additional component and water to the input means and collecting water from the output means.

The mixture of said at least one additional component and water can be entered in a pulsed manner.

Another recital of a present invention filter for separating at least one additional component from water provides that it comprise:
an outer enclosure having input and output means present thereon for entering a mixture of water and at least one additional component and exiting water, respectively, said outer enclosure being substantially closed on the sides and on the lower extent thereof, said outer enclosure having means for securing a top thereto;
a top;
an inner colander which is filled with a sequence of a mixture of polypropylene and beads in an upper majority thereof, and polypropylene in a lower minority thereof, and permeable means at the bottom thereof, said beads comprising material for ensuring that oily water continues to flow through said mixture of polypropylene and beads, by preventing oil which is separated from water thereby, from forming a blockage thereto;
   such that in use a said top is secured to said outer enclosure and a mixture of said at least one additional component and water is entered to the input means, flows through said mixture of polypropylene and beads, then through said polypropylene, and then through said permeable means at the bottom of the inner colander before water exits through said output means of the outer enclosure.

A method of separating at least one additional component from water then comprises:
a) providing a filter as described just above; and
b) entering a mixture of said at least one additional component and water to the input means and collecting water from the output means.

In both the immediately proceeding recitals the at least one additional component can be oil.

It is noted that the outer enclosure and said inner colander of the present invention system are preferably cylindrical in shape.

It is specifically noted that practice of the present invention methodology disclosed results in a concrete and tangible effect in that non-water component(s) and water are separated from one another.

It is noted for emphasis that nothing in any known prior art suggests a mixture of polypropylene and beads in the upper majority thereof, and polypropylene in the lower minority thereof. Further. It is noted that the terminology “beads”, as used in this application is to be interpreted to mean “non-hydroscopic particulates which are preferably irregular in shape with a preferred maximum dimension of 3/16, up to ⅜ inch in size as measured in any direction across or through a bead”, which beads are made of a material such that they comprise means for ensuring that oily water continues to flow through the mixture of polypropylene and beads in the upper approximately ⅔ of the Inner Colander, by preventing oil which is separated from water thereby, from forming a blockage to said flow. The important aspect of the present invention is that an inner colander is filled with a sequence of a mixture of polypropylene and beads in the upper majority thereof, and purely polypropylene (without beads) in the lower minority thereof, and that said beads be comprised of material that ensures that oily water continues to flow through said mixture of polypropylene and beads, by preventing oil which is separated from water thereby, from forming a blockage thereto. It is not considered critical to Patentability that any specific bead material be identified as no matter what the bead material, the sequence of the mixture of polypropylene and beads in the upper majority thereof, and purely polypropylene (without beads) in the lower minority thereof defines a Patentably distinct invention. However, as non-limiting and exemplary, suitable materials can be:

### SPECIFIC EXEMPLES

Specific suitable materials for application in the present invention are:

Polypropylene—identified as C.A.S. No. 25085534; and having the consistency of cotton bail.

It is noted that the Polypropylene as received is broken-up to eliminate solid chunks, and in use approximately 2 pounds thereof is packed into the lower (⅓) of the Colander, (which is of a dimension to fit inside an 8×36 inch Outer Cylinder). Preferably packing around the sidewalls is caused to be denser than is that centrally.
Beads—identified as IS30V 30 Melt, Slip PECA 16341, Additive 3/100, White Clarinet 1014699S 3/100 on the box as received, in the form of hard white “plastic” beads, and purchased from Sunoco Chemicals, Polymer Division, Pittsburgh, Pa.
   Preferably, though not necessarily, said Bead material, received as just described, is subjected to a process that results in formation of small irregular shaped pieces having a dimension thereacross or therethrough on the order of 3/16 to ⅜ inch, and a mixture thereof with the Polypropylene is prepared preferably having a relative concentration of 1 part Polypropylene to 3 parts of the beads and/or small irregular shaped pieces. About 5 pounds of mixture is packed into the upper (⅔'s) of the Colander. Preferably packing around the sidewalls is caused to be denser than is that centrally. It is noted that the terminology “Beads” in the Claims is to be interpreted sufficiently broadly to include the possibility of using plastic beads of a dimension between ⅛ and ¼ inch as they are received from a manufacturer, and/or the results of treating, (e.g. by application of heat, and/or mechanical pressure), said beads to provide said small irregular shaped pieces with the 3/16 to ⅜ inch dimension, individually or as a mixture thereof.

The terminology “High Back Pressure” should be interpreted to mean 10 PSIG when a present invention system is newly packed, increasing to 70 PSIG as filter becomes “dirty” with, for instance, collected oil. The pressure must be increased as oil accumulates in the Polypropylene to cause flow to continue. Any pressure above 70 PSIG is also included.

The terminology “Pulse Rate” is to be interpreted to mean a pressure cycle involving 10-20 seconds “On” with “Off” time determined based on condensate flow. “Off” time varies with specific installation but can be within a range of 10 seconds to a minute or more.

The present invention will be better understood by a reading of the Detailed description Section of this Disclosure with reference to the Drawings.

### BRIEF DESCRIPTION OF THE DRAWINGS

FIG. 1 shows a partially constructed side elevational cross-sectional taken at b-b in FIG. 2 of the presently disclosed invention.

FIG. 2 shows a top secured in place to an Outer Enclosure and Inner Colander.

FIG. 3 shows a top view of the top identified in FIG. 2.

### DETAILED DESCRIPTION

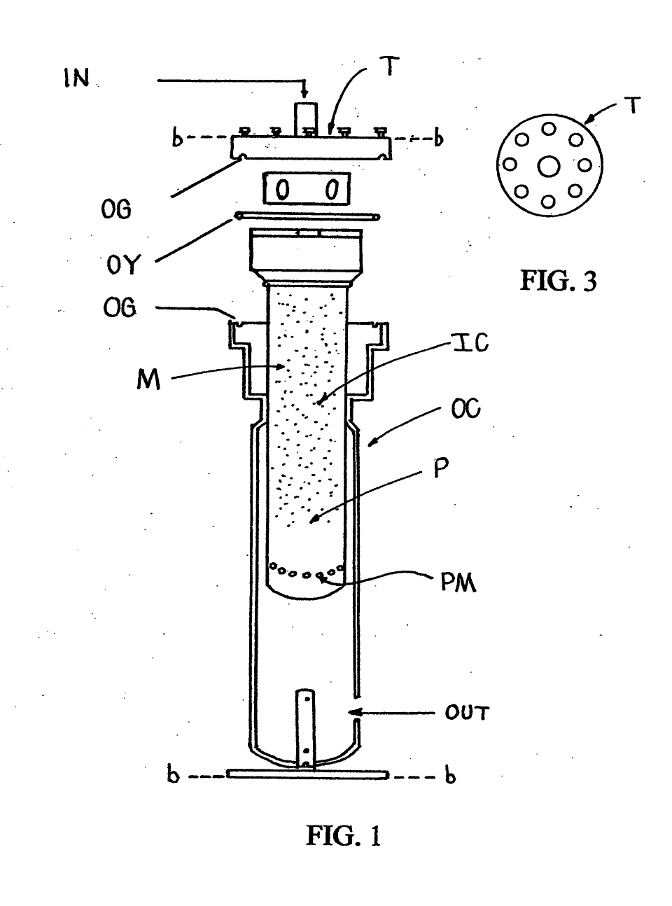

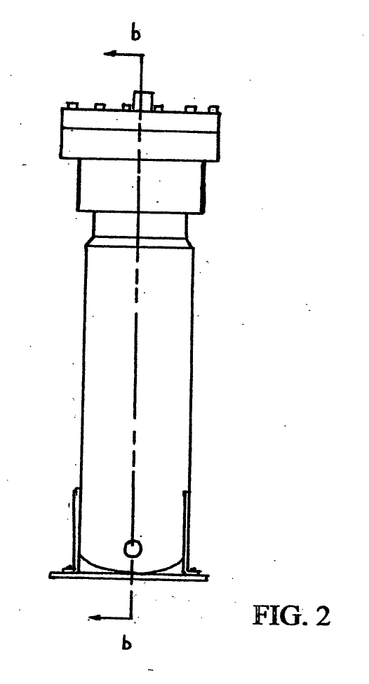

FIG. 1 shows a partially constructed side elevational view of the presently disclosed invention system. Note a Top (T), an Inner Colander (IC), and an Outer Enclosure (OC) are present. The Inner Colander positions in the Outer Enclosure, and the Top (T) secures the Inner Colander (IC) in place. There is an “O” ring present between the Top (T) and the upper aspect of the Outer Enclosure (OC). Also shown are “O” ring receiving grooves (OG). Note that the upper portion of the Inner Colander (IC) is shaped to fit in a reception region therefore in the top of the Outer Enclosure (CO), and that when the Top (T) is secured to the Outer Enclosure (C), as shown in FIG. 2, said top of the Inner Colander (IC) is secured in place.

Note also the indication of a mixture (M) of Polypropylene and Plastic Beads in the upper approximately ⅔ of the Inner Colander, and Polypropylene (P) in the lower approximately ⅓ thereof, and Permeable Means (PM) at the bottom thereof. The beads are typically ⅛ to ⅜ inch in diameter. FIG. 2 shows the system with the Top secured to the Outer Enclosure (OC), and FIG. 3 shows a Top view of the Top (T).

It is noted that the terminology “beads”, as used in this application is to be interpreted to mean “non-hydroscopic particulates which are preferably irregular in shape with a preferred maximum dimension of 3/16 up to ⅜ inch in size as measured in any direction across or through a bead”, which beads are made of a material such that they comprise means for ensuring that oily water continues to flow through the mixture of polypropylene and beads in the upper approximately ⅔ of the Inner Colander, by preventing oil which is separated from water thereby, from forming a blockage to said flow.

Having hereby disclosed the subject matter of the present invention, it should be obvious that many modifications, substitutions, and variations of the present invention are possible in view of the teachings. It is therefore to be understood that the invention may be practiced other than as specifically described, and should be limited in its breadth and scope only by the Claims.

I claim:

1. A filter for separating oil from water comprising:
an outer enclosure having input an output means present thereon for entering a mixture of water and oil and exiting water, respectively, said outer enclosure being substantially closed on the sides and on the lower extent thereof, said outer enclosure having means for securing a top thereto;
a top;
an inner colander which is filled with a sequence of a mixture of polypropylene and beads in an upper majority thereof, and polypropylene in a lower minority thereof, and permeable means at the bottom thereof, said beads comprising means for ensuring that oily water continues to flow through said mixture of polypropylene and beads, by preventing oil which is separated from water thereby, from forming a blockage thereto;
such that in use a said top is secured to said outer enclosure and a mixture of oil and water is entered to the input means, flows through said mixture of polypropylene and beads, then through said polypropylene, and then through said permeable means at the bottom of the inner colander before water exits through said output means of the outer enclosure.

2. A filter as in claim 1, wherein the terminology “upper majority” of the inner colander represents approximately ⅔ of the total volume thereof, and the terminology “lower minority” of the inner colander represents approximately ⅓ of the total volume thereof and wherein said beads are non-hydroscopic particulates which are irregular in shape with a preferred maximum dimension of 3/16, up to ⅜ inch in size, as measured in any direction across or through a bead.

3. A method of separating oil from water comprising:
a) providing a filter for separating oil from water comprising an outer enclosure having input and output means present thereon for entering a mixture of water and oil and exiting water, respectively, said outer enclosure being substantially closed on the sides and on the bottom thereof, said outer enclosure having means for securing a top thereto;
a top;
an inner colander which is filled with a sequence of a mixture of polypropylene and beads in an upper majority thereof, and polypropylene in a lower minority thereof, and permeable means at the bottom thereof, said beads comprising means for ensuring that oily water continues to flow through said mixture of polypropylene and beads, by preventing oil which is separated from water thereby, from forming a blockage thereto;
such that in use a said top is secured to said outer enclosure and a mixture of oil and water is entered to the input means, flows through said mixture of polypropylene and beads, then through said polypropylene, and then through said permeable means at the bottom of the inner colander before water exits through said output means of the outer enclosure;
b) entering a mixture of oil and water to the input means and collecting water from the output means.

4. A method as in claim 3, in which the mixture of oil and water is entered in a pulsed manner.

5. A filter for separating at least one additional component from water comprising:
an outer enclosure having input and output means present thereon for entering a mixture of water and at least one additional component and exiting water, respectively, said outer enclosure being substantially closed on the sides and on the lower extent thereof, said outer enclosure having means for securing a top thereto;
a top;
an inner colander which is filled with a sequence of a mixture of polypropylene and beads in an upper majority thereof, and polypropylene in a lower minority thereof, and permeable means at the bottom thereof, said beads comprising means for ensuring that oily water continues to flow through said mixture of polypropylene and beads, by preventing oil which is separated from water thereby, from forming a blockage thereto;
such that in use a said top is secured to said outer enclosure and a mixture of said at least one additional component and water is entered to the input means, flows through said mixture of polypropylene and beads, then through said polypropylene, and then through said permeable means at the bottom of the inner colander before water exits through said output means of the outer enclosure.

6. A filter and in claim 5, wherein the terminology “upper majority” of the inner colander represents approximately ⅔ of the total volume thereof, and the terminology “lower minority” of the inner colander represents approximately ⅓ of the total volume thereof, and wherein said beads are non-hydroscopic particulates which are irregular in shape with a preferred maximum dimension of 3/16, up to ⅜ inch in size, as measured in any direction across or through a bead.

7. A method of separating at least one additional component from water comprising:
a) providing a filter for separating at least one additional component from water comprising an outer enclosure having input and output means present thereon for entering a mixture of water and at least one additional component and exiting water, respectively, said outer enclosure being substantially closed on the sides and on the bottom thereof, said outer enclosure having means for securing a top thereto;
a top;
an inner colander which is filled with a sequence of a mixture of polypropylene and beads in an upper majority thereof, and polypropylene in a lower minority thereof, and permeable means at the bottom thereof, said beads comprising means for ensuring that oily water continues to flow through said mixture of polypropylene and beads, by preventing oil which is separated from water thereby, from forming a blockage thereto;
such that in use a said top is secured to said outer enclosure and a mixture of at least one additional component and water is entered to the input means, flows through said mixture of polypropylene and beads, then through said polypropylene, and then through said permeable means at the bottom of the inner colander before water exits through said output means of the outer enclosure;
b) entering a mixture of said at least one additional component and water to the input means and collecting water from the output means.

8. A method as in claim 7, in which the mixture of said at least one additional component and water is entered in a pulsed manner.

9. A filter as in claim 1, in which said outer enclosure and said inner colander are cylindrical in shape.

10. A method as in claim 3, in which said provided outer enclosure and said provided inner colander are cylindrical in shape.

11. A filter as in claim 5, in which said outer enclosure and said inner colander are cylindrical in shape.

12. A method as in claim 7, in which said provided outer enclosure and said provided inner colander are cylindrical in shape.

13. A filter as in claim 1, in which said beads are comprised of at least one material selected from the group consisting of:

14. A method as in claim 3, in which said beads are comprised of at least one material selected from the group consisting of:

15. A filter as in claim 5, in which said beads are comprised of at least one material selected from the group consisting of:

16. A method as in claim 7, in which said beads are comprised of at least one material selected from the group consisting of:

17. A filter for separating at least one additional component from water comprising:
an outer enclosure having input and output means present thereon for entering a mixture of water and at least one additional component and exiting water, respectively, said outer enclosure being substantially closed on the sides and on the lower extent thereof, said outer enclosure having means for securing a top thereto;
a top;
an inner colander which is filled with a sequence of a mixture of polypropylene and beads in an upper majority thereof, and polypropylene in a lower minority thereof, and permeable means at the bottom thereof, said beads comprising material for ensuring that oily water continues to flow through said mixture of polypropylene and beads, by preventing oil which is separated from water thereby, from forming a blockage thereto;
such that in use a said top is secured to said outer enclosure and a mixture of said at least one additional component and water is entered to the input means, flows through said mixture of polypropylene and beads, then through said polypropylene, and then through said permeable means at the bottom of the inner colander before water exits through said output means of the outer enclosure.

18. A filter as in claim 17 in which the at least one additional component is oil.

19. A filter as in claim 17, in which said enclosure and said colander are cylindrical in shape.

20. A method of separating at least one additional component from water comprising:
a) providing a filter for separating at least one additional component from water comprising an outer enclosure having input and output means present thereon for entering a mixture of water and at least one additional component and exiting water, respectively, said outer enclosure being substantially closed on the sides and on the bottom thereof, said outer enclosure having means for securing a top thereto;
a top;
an inner colander which is filled with a sequence of a mixture of polypropylene and beads in an upper majority thereof, and polypropylene in a lower minority thereof, and permeable means at the bottom thereof, said beads comprising material for ensuring that oily water continues to flow through said mixture of polypropylene and beads, by preventing oil which is separated from water thereby, from forming a blockage thereto;
such that in use a said top is secured to said outer enclosure and a mixture of at least one additional component and water is entered to the input means, flows through said mixture of polypropylene and beads, then through said polypropylene, and then through said permeable means at the bottom of the inner colander before water exits through said output means of the outer enclosure;
b) entering a mixture of said at least one additional component and water to the input means and collecting water from the output means.

21. A method as in claim 20 in which the at least one additional component is oil.
